(19) United States
(12) Patent Application Publication
(10) Pub. No.: US 2005/0007659 A1
(43) Pub. Date: Jan. 13, 2005

(54) Focusing mechanism for stereoscopic systems

(75) Inventors: M. Gregory Steinthal, Los Angeles, CA (US); David Sherlock, Glendale, CA (US); Behrokh Khoshnevis, Marina Del Rey, CA (US)

Correspondence Address: Richard C. Hsu, 505 Seville Way, San Mateo, CA, 94402, US

(73) Assignee: StereoVision Imaging, Inc., Alta Dena, CA (US)

(21) Appl. No.: 10/655,228

(22) Filed: Sep. 3, 2003

Related U.S. Application Data
(60) Provisional application No. 60/408,186, filed on Sep. 3, 2002.

(51) Int. Cl. G02B 21/00

(52) U.S. Cl. 359/383; 359/376

(57) ABSTRACT

A hand held stereoscopic system in which the focusing to the eye and CMOS photo array of near and distant objects is controlled simultaneously by moving the imaging system.

### FIELD OF THE INVENTION

The general field of the present invention is a focusing mechanism for a hand-held stereoscopic systems. Specifically, however, the invention relates to simultaneously stereo images to the eye and to a focusing mechanism for solid state stereoscopic imaging system housed within a traditional hand-held pair of prism binoculars.

### BACKGROUND OF THE INVENTION

The use of prisms to produce enlarged images of distant objects dates back centuries, beginning, according to the history books, when Galileo first held up two prisms and gazed through them. Soon, the appropriated juxtaposed prisms were incorporated into elongated telescopes through which the viewer peered using one eye. The image presented was, of course, flat, consisting of only two dimensions. Much later, it was realized that by holding a telescope to each eye, a stereoscopic image was perceived. However, holding up two telescopes at the same time was not particularly easy, and was definitely not very convenient, thus the same technology was incorporated into what was to become the now well-known pair of hand-held binoculars.

The conventional pair of binocular is basically two small refracting telescopes held together by a frame that positions the telescopes, one to each of the viewer's eyes. Because the binocular incorporates a separate telescope for each eye, it therefore produces a stereoscopic or three-dimensional view that adds “depth” the image as perceived in the viewer's brain.

Each refracting telescope in the binocular has an optical path defined through an objective lens at the end nearest the object being viewed, a pair of prisms appropriately arranged within the telescope's tubular body, and an eye piece that is a the end nearest the viewer's eye. The diameter of the objective lens determines the light-gathering power. The objective lenses (in the two adjacent telescopes) are often spaced farther apart than the eyepieces so as to enhance stereoscopic vision. Functioning as a magnifier, the eyepiece forms a large virtual image that becomes the object for the eye itself and thus forms the final image on the retina. Because of the spacing between the objective lenses, the object is “viewed” from a slightly different angle by each lens and therefore collects a slightly different image. Thus, the image projected onto the retina of each eye is also slightly different, and when the viewer's brain incorporates and melds the two slightly different images received through both eyes, the viewer perceives a unified but 3-D or stereoscopic image.

Binoculars are now in ubiquitous usage throughout the world in many, many human endeavors from bird watching to opera-going to star-gazing. Over the years since the binocular was first introduced, many improvements have been made. Until recently, however, these improvements related mainly to refinements in the quality of the binoculars basic component parts, such as improving the optical components to produce clearer images, increasing magnification, adding image stabilization, making them adjustable, making them more durable, making them smaller, making them more ergonomically balanced, adding low light capability, etc. The focusing mechanism used in traditional binocular pair is typically controlled by moving the eyepieces back and forth by a knob located centrally between the two refracting telescope channels. Unlike the conventional binoculars the distance between the objective lenses can be performed without any pivoting action. This is useful when a digital camera is mounted on the same platform that holds the objective lens. A pivoting action in this case moves the camera and hence tilts the image. The reciprocal motion in the new concept prevents such problems.

Accordingly, there is a need in the art for a system that offers a focusing mechanism using other optics, which are required in all traditional binocular pairs.

### SUMMARY OF THE INVENTION

The present invention develops a new, novel way of focusing a stereoscopic device by moving the objective lenses or prisms the same distance simultaneously. The stereoscopic device can be a hand-held optical viewing device, a 3 dimensional imaging system or a pair of binoculars. The movement of the objective lenses or prisms in concert will focus near and distant objects to the eye and image detector simultaneously. The image detector can be a CMOS photo array, a charge couple device (“CCD”) or an optical sensor. Similar to the movement of the eyepieces to focus, the present invention will use the objective lenses to focus.

The present invention is a hand-held stereoscopic optical viewing device which utilizes 2 refracting telescopes having an objective lens or prism and eyepiece which is mounted on a frame. This viewing device could be a 3-dimensional imaging system, an optical viewing system or a pair of binoculars. The device also contains an embedded stereoscopic imaging or optical viewing system which contains an image detector such as, by way of an example, a CMOS photo array, charge coupled device or optical sensor and imaging optics to record images. The embedded stereoscopic imaging or optical viewing system thus defines an optical path. Finally, the focusing mechanism simultaneously focuses the images to the eyepiece and to the embedded stereoscopic imaging system by either automatically or manually adjusting the focal length or field of view.

In still another, separate aspect of the present invention, the movement of the objective lenses will be moved either automatically or manually in concert with each other the same distance.

In yet another, separate aspect of the present invention, the objectives lenses movement will be controlled by a knob.

Still another, separate aspect of the present invention, the objective lenses could be movement could be electrically motorized and controlled by a switch/button.

In yet still another, separate aspect of the present invention, the focusing mechanism could consists of a bar, knob, wire system and/or a knob, linear slide, chain system.

The device of this invention can be used for outdoor/indoor 3-D viewing and focusing the device by moving the objective lenses.

Accordingly, it is the primary object of the present invention to provide a new and novel method to focus a near or distant object simultaneously to the eye and imaging system in a stereoscopic device by moving the objective lenses. The imaging system can be embedded in the housing and includes any optical sensor and imaging optics to record images, such as CCD photo arrays or charge coupled devices. This and further objects and advantages will be apparent to those skilled in the art in connection with the drawings and the detailed description of the preferred embodiment set forth below.

### BRIEF DESCRIPTION OF THE DRAWINGS

FIG. 1 is a perspective view of the stereoscopic imaging device that houses all of the components of this invention.

FIGS. 2 is another perspective of the stereoscopic imaging device that houses all of the components of this invention.

FIG. 3 is an internal top view of the present invention illustrating the objective lens new and novel focusing mechanism.

FIG. 4 is an alternative design using bevel gears and lead screws illustrating the objective lens new and novel focusing mechanism.

### DETAILED DESCRIPTION OF THE PREFERRED EMBODIMENTS

A stereoscopic effect is the creation of the illusion of three dimensions (that is, the appearance of depth or solidity) in a two-dimensional image. Superimposing two different views of the same scene to form a composite image, the composite being at the point where the two lines of sight cross one another, can create this effect. If the two views are laterally displaced from one another by an amount approximately equal to the distance between the viewer's eyes, the resulting image will have essentially the same three-dimensional appearance as if the viewer were seeing the scene with the naked eye. Where the separation is greater than that between the viewer's eyes, the three-dimensional effect is exaggerated. Similarly, if the distance is less, the three-dimensional effect is minimized. As mentioned in the Background section above, humans and most animals achieve this effect naturally because their eyes are spaced a distance apart. The image seen by each eye is at a slightly different angle or perspective relative to the object being viewed. When these two images are “superimposed” within the brain, the image perceived is three-dimensional. To maintain this stereoscopic imagery during magnification, the conventional binoculars were developed.

For this reason, today's existing hand-held binoculars are a perfect platform upon which to integrate a solid-state stereoscopic imaging system. The binocular optics needed to create the 3-D effect are already in place, the distance between the eye pieces has been optimized, and binoculars in general have passed the test of time for improved image enhancement, ergonomics, comfort and reliability. Therefore, the basic components of the conventional binoculars form the framework within which the inventive elements herein described are housed.

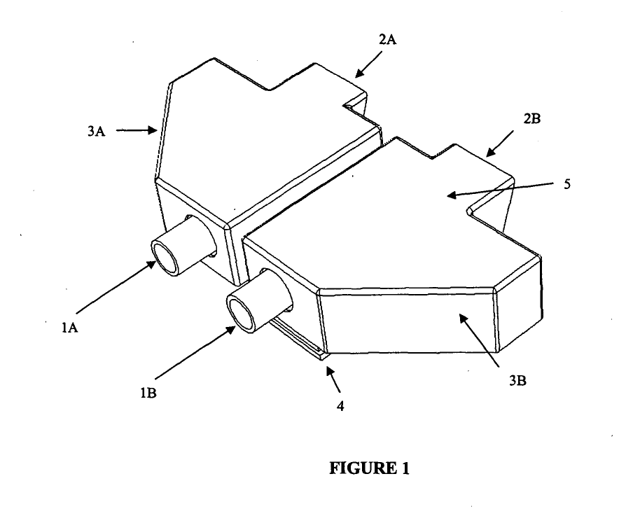

Referring now to FIG. 1 the complete package of the present invention looks very similar to today's hand-held binoculars 5. A pair of binoculars is basically two small refracting telescopes 3A and 3B are held together by a frame 4 that, by definition, holds the telescopes 3A and 3B sufficiently far apart such that once their separate images are superimposed on one another, a stereoscopic or three-dimensional view is produced. As in most binoculars, the frame 4 allows the distance between the telescopes 3A and 3B to be adjusted so as to accommodate the differences in the distance between the eyes of multiple users. As in the traditional binoculars, the externally visible components include the objective lenses 2A and 2B at the distal end of each of the telescopes 3A and 3B, and eyepieces 1A and 1B.

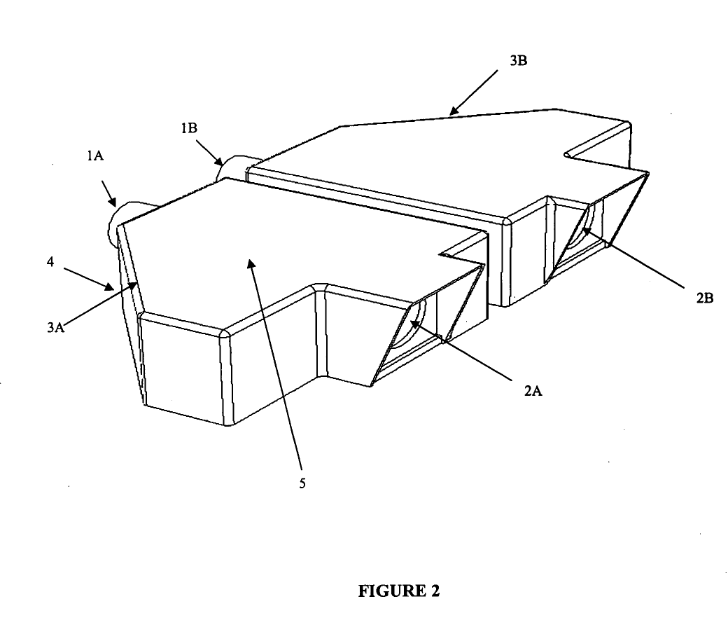

FIG. 2 is another perspective of the complete package of the present invention looks very similar to today's hand-held binoculars 5. A pair of binoculars is basically two small refracting telescopes 3A and 3B are held together by a frame 4 that, by definition, holds the telescopes 3A and 3B sufficiently far apart such that once their separate images are superimposed on one another, a stereoscopic or three-dimensional view is produced. As in most binoculars, the frame 4 allows the distance between the telescopes 3A and 3B to be adjusted so as to accommodate the differences in the distance between the eyes of multiple users. As in the traditional binoculars, the externally visible components include the objective lenses 2A and 2B at the distal end of each of the telescopes 3A and 3B, and eyepieces 1A and 1B.

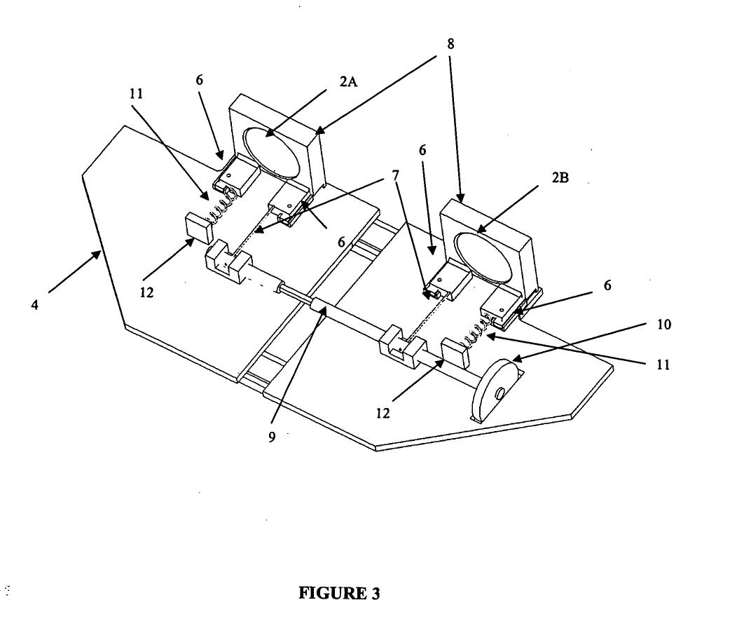

FIG. 3 is an internal view of the stereoscopic system similar to today's hand held binoculars 5 with the focusing mechanism. The focusing mechanism consists of a knob 10 which when turned rotates the bar 9. When the bar 9 turns the wires 7 wrap around the bar which causes the linear ball slides 6 connected to the objective lens holders 8 to move simultaneously. The objective lenses 2A and 2B in the objective lens holders 8 is able to move back and forth using tension from springs 11 attached to the frame 4, a spring stop 12 and the objective lens holders 8 via screws. The bar 9 is made out of two telescopic pieces. The outside surfaces of these pieces where the tension wire 7 is wound are tubular and of the same diameter. One bar 9 has a square hole along its length while the other has a matching square bar that goes into the square hole. This allows for coordinated rotational motion for focusing to the eye and the CMOS photo array as well as reciprocal motion for eye distance adjustment.

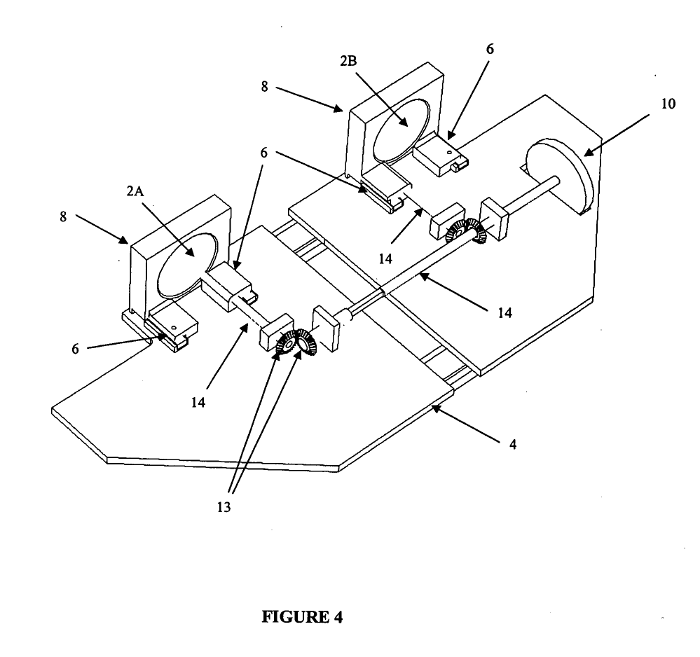

FIG. 4 is an alternative design using bevel gears 13 and lead screws 14. This design is more robust and requires no springs. The focusing mechanism consists of a knob 10 which when turned rotates the bevel gears 13 which turn the lead screws 14. When the lead screws 14 turn which causes the linear ball slides 6 connected to the objective lens holders 8 to move simultaneously. The objective lenses 2A and 2B in the objective lens holders 8 is able to move back and forth using the bevel screws 13 and the lead screws 14. The lead screws 14 are made out of two telescopic pieces. One lead screw 14 has a square hole along its length while the other has a matching square bar that goes into the square hole. This allows for coordinated rotational motion for focusing to the eye and the CMOS photo array as well as reciprocal motion for eye distance adjustment.

It will be readily apparent to those skilled in the art that still further changes and modification in the actual concepts described herein can readily be made without departing from the spirit and scope of the invention as defined by the following claims.

1. A hand-held, stereoscopic optical viewing device comprising:
a) at least on (1) pair of refracting telescopes having an objective lens and eyepiece mounted on a frame;
b) an embedded stereoscopic imaging system having an image detector; and
c) a focusing mechanism which simultaneously focuses the images to the eyepiece and said embedded steresocopic imaging system.

2. A hand-held, stereoscopic optical viewing device of claim 1 wherein said device is a 3-dimensional imaging system.

3. A hand-held, stereoscopic optical viewing device of claim 1 wherein said device is a binocular.

4. A hand-held, stereoscopic optical viewing device of claim 1 wherein said image detector comprises a CMOS photo array.

5. A hand-held, stereoscopic optical viewing device of claim 1 wherein said image detector comprises a charge coupled device (“CCD”).

6. A hand-held, stereoscopic optical viewing devices of claim 1 wherein said image detector comprises an optical sensor.

7. A hand-held stereoscopic system, comprising:
a) an optical viewing system having an objective lens, prism and eyepiece with an optical path defined therein;
b) an embedded imaging system having an optical sensor to record images from said optical path;
c) a movable objective lens which simultaneously adjusts the focal length of (a) of the optical viewing system and (b) of the embedded imaging system.

8. A hand-held stereoscopic system of claim 8 wherein said system is an optical viewing device.

9. A hand-held stereoscopic system of claim 8 wherein said system is a 3-dimensional imaging system.

10. A hand-held stereoscopic system of claim 8 wherein said system is a binocular.

11. A hand-held stereoscopic system of claim 8 wherein said objective lens is adjustable.

12. A hand-held stereoscopic system of claim 8 wherein said focal length is the field of view.

13. A hand-held stereoscopic system of claim 8 wherein said movable objective lens may be adjusted either manually or automatically.

14. A method for simultaneously focusing the optical viewing system and the embedded imaging system in a hand-held stereoscopic system wherein:
a) said optical viewing system is comprised of an objective lens, prism and eyepiece; and
b) said embedded imaging system is comprised of an optical sensor and imaging optics to record images.

15. A method of claim 15 wherein the objective lens may be adjusted either manually or automatically.
